(19) United States
(12) Patent Application Publication
(10) Pub. No.: US 2018/0016006 A1
(43) Pub. Date: Jan. 18, 2018

(54) Smart unmanned aerial vehicle for home

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/719,091

(22) Filed: Sep. 28, 2017

(30) Foreign Application Priority Data
Jan. 22, 2017 (CN) 201710048455.4
Jan. 22, 2017 (CN) 201720083266.6

(51) Int. Cl. B64C 39/02; B60L 11/18; G10L 17/00; G10L 15/22; G06K 9/62; B64C 25/10; G06K 9/00; G06F 17/30; G05D 1/00; B64D 1/22; G10L 17/02; G10L 17/22; G06K 9/46

(52) U.S. Cl. CPC B64C 39/024; G10L 17/22; B60L 11/1833; G10L 17/005; G10L 15/22; G06K 9/6202; G06K 9/46; G06K 9/00771; G06K 9/00637; G06K 9/00288; G06K 9/00255; G06K 9/00201; G06F 17/30247; G05D 1/0061; B64D 1/22; G10L 17/02; B60L 11/1861; B64C 25/10; B64C 2201/126; B64C 2201/042; B64C 2201/027; B64C 2201/127; B64C 2201/141; B64C 2201/146

(57) ABSTRACT

The present invention discloses a smart unmanned aerial vehicle for home which includes a route reconnaissance module to respond to reconnaissance instructions which instruct the unmanned aerial vehicle to patrol a house according to a preset flight route; a feature recognition module to recognize family members and different reactions of the family members toward the unmanned aerial vehicle for generating and recording an instruction set for different family members; a control module to generate reconnaissance instructions according to external reconnaissance control signals, wherein when exception occurs, warning signals are generated; the control module interrupts a patrol according to an external patrol interruption signal or when the feature recognition module recognizes the family members; the control module responds or waits for a response to the control signals for actions of the feature recognition module. The present invention is customized for family members, which is able to monitor and etc.

### CROSS REFERENCE OF RELATED APPLICATION

The present invention claims priority under 35 U.S.C. 119(a-d) to CN 201710048455.4, filed Jan. 22, 2017; and CN 201720083266.6, filed Jan. 22, 2017.

### BACKGROUND OF THE PRESENT INVENTION

### Field of Invention

The present invention relates to an unmanned aerial vehicle, and more particularly to a smart unmanned aerial vehicle for home.

### Description of Related Arts

The applications of conventional unmanned aerial vehicle are limited within professional fields, such as the forest fire prevention, cable inspection, agricultural plant protection, aerial video and etc. The unmanned aerial vehicle is also able to be used for selfie, flight control experience and etc. The conventional unmanned aerial vehicle is not applied in the mass market and does not meet the development trend of intelligent society.

With the improvement of the living condition, more and more family hires housekeeper or housemaid to manage the household, nurse or accompany the kids. Due to the increasing labor cost, the willingness and health condition of the housekeeper, the housekeeper is unable to work for a long time. The demand for intelligent housekeeper and intelligent vehicle as family member is pressing. Conventionally, no solutions for unmanned aerial vehicle to work as the housekeeper or the family member are provided.

Besides, although the propellers of the conventional unmanned aerial vehicle are protected by the protective frame, the propellers may cause damages to the unmanned aerial vehicle, the houseware or the human because the unmanned aerial vehicle for home runs in the household frequently.

### SUMMARY OF THE PRESENT INVENTION

An object of the present invention is to provide a smart unmanned aerial vehicle for home which is able to be customized for family members and carry out monitoring function etc.

In order to solve the problems of conventional unmanned aerial vehicle, the present invention provides a smart unmanned aerial vehicle for home which comprises:

a route reconnaissance module to respond to reconnaissance instructions which instruct the vehicle to patrol a house according to a preset flight route;

a feature recognition module to recognize family members and different reactions of the family members toward the vehicle for generating and recording an instruction set for different family members, wherein control signals for actions taking by the vehicle toward the family members are generated according to a repeat frequency of instructions in the instruction set;

a control module to generate reconnaissance instructions according to external reconnaissance control signals, wherein the control module controls the route reconnaissance module to patrol within a set period of time and the feature recognition module to recognize abnormal object features, wherein when exception occurs, warning signals are generated; the control module interrupts a patrol according to an external patrol interruption signal or when the feature recognition module recognizes the family members; the control module responds or waits for a response to the control signals for actions of the feature recognition module.

Referring to an embodiment of the present invention, the smart unmanned aerial vehicle for home comprises a vision-based 3D (three-dimensional) scanning module which picks up and transmits house images to the control module during patrol; the control module revises a route preset in the route reconnaissance module based on obstacles along a direction of flight in the house images and adjusts heading of a flight path; the control module is also for comparing the house images picked up in a same spot at different time points, wherein when a distinguishing feature exists, the control module extracts the distinguishing feature and inquires the distinguishing feature in the database; if an inquiry is answered the control module generates warning signals.

Referring to an embodiment of the present invention, the smart unmanned aerial vehicle for home comprises a remote communication module to respond to the warning signals from the control module and call a remote terminal, wherein a communication link is established after a response has been committed, which enables a remote control.

Referring to an embodiment of the present invention, the feature recognition module comprises:

a feature storage module for storing a feature database;

a human face recognition module to recognize faces of the family members and inquire a human face feature database in the feature storage module, wherein if the faces do not exist, human face feature records are established for the family members;

a voice recognition module to recognize voices of the family members after the faces of the family members are recognized and inquire a voice feature database in the feature storage module, wherein a voice instruction is achieved based on the voice feature and a voice instruction set of the family members is generated and recorded; wherein the voice recognition module calculates a repeat frequency of a same voice instruction in the voice instruction set and control signals for actions toward the family member are generated according to the repeat frequency.

Referring to an embodiment of the present invention, the feature recognition module further comprises a lifeform identification module to identify an abnormal lifeform feature when the route reconnaissance module is under a patrol mode, generate and transmit exception signals to the control module.

Referring to an embodiment of the present invention, the smart unmanned aerial vehicle for home comprises a warning device to respond to the warning signals and sound a warning.

Referring to an embodiment of the present invention, the smart unmanned aerial vehicle for home comprises a charging management module to check a charging module power in the vehicle and generate low power return charging signals when the power is low before the low power return charging signals are transmitted to the control model; the control module responses to the low power return charging signals and controls the vehicle to return to a charging device for charging along a preset flight route.

Referring to an embodiment of the present invention, an all-inclusive protective cover is disposed at an outside of propellers of the vehicle; multiple air holes are disposed on the all-inclusive protective cover; the propellers are able to rotate freely within the all-inclusive protective cover.

Referring to an embodiment of the present invention, the all-inclusive protective cover comprises a detachable top protective cover and a bottom protective cover; the top protective cover and the bottom protective cover surround a main body, arms and propellers within.

Referring to an embodiment of the present invention, a middle part of the all-inclusive protective cover is part of a body shell of the vehicle; an accommodating part for a landing gear extension or retraction is disposed on the middle part of the all-inclusive protective cover.

Referring to an embodiment of the present invention, flexible rubber is adopted for a whole body of the all-inclusive protective cover, the whole body except a middle part of the all-inclusive protective cover and an edge part of the all-inclusive protective cover.

Referring to an embodiment of the present invention, the smart unmanned aerial vehicle for home comprises a holder which is disposed on the vehicle and extends out from a body shell of the vehicle; the holder responses to a hold instruction from the control module to hold or release an object, wherein the hold instruction is a response to an external hold control signal by the control module.

Compared to the conventional technology, the present invention has the below benefits:

The route reconnaissance module, feature recognition module and control module cooperate to record and recognize every family member, study the habit and preference of the every family member according to the instruction set of the family member. The vehicle is able to act according to the habit and preference of the family member, which possesses self-consciousness and characters. The vehicle is able to accompany or play with the kids while the parents are working and escort the kid to school from the upper air. The unmanned aerial vehicle is able to act as a housekeeper and a security guard to monitor and patrol around the house and the surroundings if nobody is at home such as when the family members go to work or take vacations. The vehicle is able to sound a warning when abnormal situation occurs and realize remote control patrol. Compared to the adoption of multiple monitor cameras, the unmanned aerial vehicle has the advantages of low cost, no blind spot, high degree of freedom, driving the invading animals in real time and etc. The unmanned aerial vehicle switches to family member accompany mode from patrol mode through the external control or after family members are recognized, which avoids a wrong judgment on non-family members or new situations.

The vision-based 3D (three-dimensional) scanning module and the control module cooperate to revise the preset flight route in the route reconnaissance module and adjust the route smartly to keep the vehicle free from obstacles. The vision-based 3D scanning module is able to spot the abnormal situation in the house and give out warning signals to inform the family members about the abnormal situation.

The all-inclusive cover surrounds the whole propellers. While the unmanned aerial vehicle for home frequently runs in the house and the surroundings, the all-inclusive cover protects the propellers from being touched by the human or houseware in all directions, which avoids the possible damages to the vehicle, the houseware or the personnel. The air holes on the all-inclusive cover enable the propellers to provide the airstream power to the unmanned aerial vehicle.

### BRIEF DESCRIPTION OF THE DRAWINGS

FIG. 1 is a flowchart of a smart unmanned aerial vehicle for home according to a preferred embodiment of the present invention;

FIG. 2 is a flowchart of the smart unmanned aerial vehicle for home according to another preferred embodiment of the present invention;

FIG. 3 is a perspective view of the structure of the smart unmanned aerial vehicle for home according to a preferred embodiment of the present invention;

FIG. 4 is a perspective view of the structure of the smart unmanned aerial vehicle for home in the FIG. 3 from another angle.

### DETAILED DESCRIPTION OF THE PREFERRED EMBODIMENT

Referring to the drawings, according to a preferred embodiment of the present invention, the objects, features and advantages of the present invention are explained clearly and easy to understand.

The details listed below are for a better understanding of the present invention. The present invention is able to be carried out with method different from the embodiment. The skilled technicians in the field are able to conceive similar methods in the spirit of the present invention. The embodiments are not a limitation for the present invention.

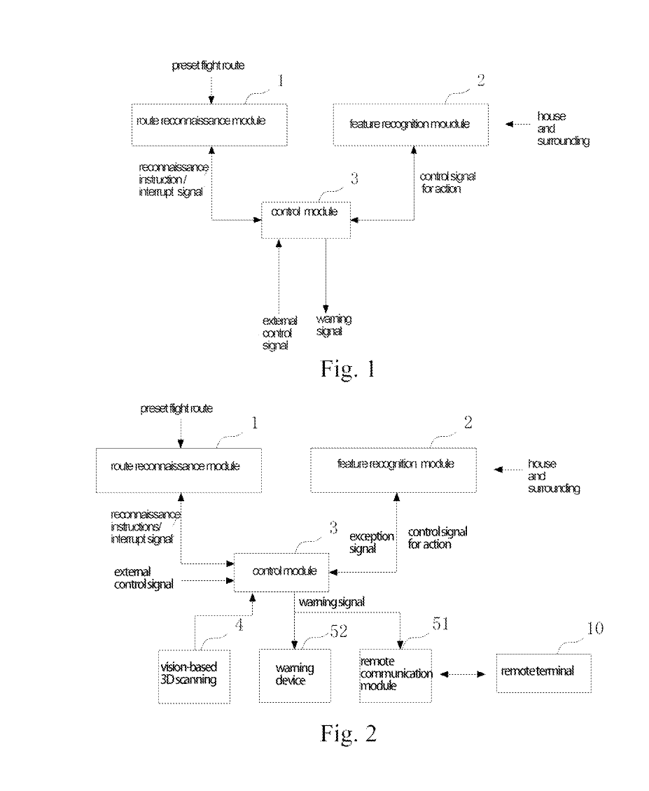

Referring to the FIG. 1, according to a preferred embodiment, the smart unmanned aerial vehicle for home comprises the route reconnaissance module 1, the feature recognition module 2 and the control module 3. The smart unmanned aerial vehicle for home in the present invention may comprises the regular parts of the unmanned aerial vehicle, such as the main body, the arm, the propellers, the flight control module, the charging module and etc. which is not fully described. The smart unmanned aerial vehicle is able to work around the clock and switch between multiple modes. The vehicle is able to interact with the family members and patrol around the house when nobody is at home. An enhanced imaging module is disposed on the vehicle, which assists the imaging unit (route reconnaissance module 1) and the feature recognition module 2 to pickup aerial images interrupt free and from a wide angle.

The route reconnaissance module responds to the reconnaissance instructions, which enables the vehicle to patrol the house along a preset flight route. The preset flight route may be achieved by a laser reconnaissance device while the unmanned aerial vehicle flying, wherein the reconnaissance information on the position of objects is formed based on the time difference between the transmitting and the feedback of the signals; the reconnaissance information is transmitted to the control module 3 which constructs a map of the flight environment; a route is planned according to the map as the preset flight route. The preset flight route is also able to be achieved by recording the flight tracks while the manual flight control. The preset flight route is for controlling the heading of the flight. Multiple markers which are able to be identified by the route reconnaissance module are placed in the house to be the route spot guide. The laser reconnaissance device automatically matches the detected markers with the marks on the saved environment map and calculates the current coordinates to position the vehicle. The vehicle is also able to be positioned by a GPS (Global Positioning System) module or an optical flow camera module. The control module 3 generates the reconnaissance instructions according to the external reconnaissance control signals. The external reconnaissance control signals are in various forms according to the demands of the customers, such as voice, password, fingerprint, screen interaction and etc. Corresponding modules are able to be disposed on the vehicle to receive the signals in various forms

The feature recognition module 2 is for recognizing the family members, identifying different features of the family members, such as acts or voices, generating corresponding instruction according to different features of the family members, and recording all the instructions of one family member as an instruction set. Instruction sets are recorded for and one-to-one correspond to different family members. The feature recognition module calculates the repeat frequency of different instructions in the instruction set and forms the control signals for actions of the vehicle toward the family members according to the repeat frequency. For example, the most frequently repeated instructions in the instruction set are selected as the habit and preference features of the family member, according to which the control signals for action of the vehicle toward the family members are generated.

The control module 3 is able to receive the external control signals which are input from the remote control terminal or the wireless terminal. The control module 3 is connected to the route reconnaissance module and the feature recognition module. The control module 3 generates reconnaissance instructions according to the external reconnaissance control signals. Within the set period of time, the timing module controls the reconnaissance time and the reconnaissance instructions control the route reconnaissance module 1 to patrol. The control module controls the route reconnaissance module 1 to patrol along the preset flight route. Meanwhile, the feature recognition module 2 keeps identifying the objects under the control of the control module 3. When an abnormal object (non-family member) is identified, the control module 3 gives out warning signals to inform that a stranger enters the house. The control module 3 interrupts a patrol according to an external patrol interruption signal or when the feature recognition module 2 recognizes the family members; the control module responds or waits for a response to the control signals for actions of the feature recognition module 2, wherein the patrol module is switched to the family member accompany mode.

The route reconnaissance module 1, the feature recognition module 2 and the control module 3 cooperate to record and recognize every family member and study the habits and preferences of every family member according to the instruction set of different family members. The vehicle is able to act according to the habit and preference of the family member, which possesses self-consciousness and characters. The vehicle is able to accompany or play with the kids while the parents are working and escort the kid to school from the upper air. The unmanned aerial vehicle is able to act as a housekeeper and a security guard to monitor and patrol around the house and the surroundings if nobody is at home such as when the family members go to work or take vacations. The vehicle is able to sound a warning when abnormal situation occurs and realize remote control patrol. Compared to the adoption of multiple monitor cameras, the unmanned aerial vehicle has the advantages of low cost, no blind spot, high degree of freedom, driving the invading animals in real time and etc. The unmanned aerial vehicle switches to family member accompany mode from patrol mode through the external control or after family members are recognized, which avoids a wrong judgment on non-family members or new situations.

Referring to the FIG. 2, according to an embodiment of the present invention, the smart unmanned aerial vehicle for home comprises a vision-based 3D scanning module 4 which is connected to the control module 3, such as a laser 3D vision system. The vision-based 3D scanning module 4 picks up house images while the vehicle is in a patrol mode and transmits the images to the control module 3. A 3D view of the house and the surroundings is established with the images. The vision-based 3D scanning module 4 is also able to detect the obstacles ahead. The control module 3 constructs a route model according to the images picked up by the vision-based 3D scanning module 4 and the obstacles along the flight direction to revise the preset flight route in the route reconnaissance module 1 and adjust the heading of the flight. For example, when obstacles lies ahead, the environment map changes and the preset flight route is adjusted to avoid the obstacles, wherein the heading of the flight is adjusted accordingly. After the route is revised, the vehicle switches to the patrol mode from the modeling mode. The control module 3 also compares the house images picked up in a same spot at different time points, wherein when a distinguishing feature exists, the control module extracts the distinguishing feature and inquires the distinguishing feature in the database; if an inquiry is answered the control module generates warning signals.

The comparison and extraction of the features of the image are able to be realized by common image processing techniques and no further explanation is needed. The distinguishing feature database is established by studying the abnormal situations and capturing the abnormal features which are saved in the database as an abnormality set. For example, the vehicle captures the abnormal features of the fire by studying the image of the flame, captures the abnormal features of the smoke by studying the image of the smoke, or captures the abnormal features of the leakage by studying the image of water stains on the ground. The feature information is able to be edges, grayscale, colors, texture, shape, positional relations and etc.

The vision-based 3D scanning module 4 and the control module 3 cooperate to revise the preset flight route in the route reconnaissance module 1 and smartly adjust the route to prevent the unmanned aerial vehicle from hitting the obstacles in time. The vision-based 3D scanning module 4 is able to spot the abnormal situation in the house and sound warning signals to inform the family members.

Referring to the FIG. 2, according to a preferred embodiment of the present invention, the smart unmanned aerial vehicle for home comprises a remote communication module 51 which is connected to the control module 3 and is able to receive the warning signals. The remote communication module 51 respond to the warning signals from the control module 3 and call a remote terminal 10, wherein a communication link is established after a response has been committed, which enables a remote control. The family members check, judge and deal with the abnormal situation by remote control. The remote communication module 51 is able to be a GPRS (General Packet Radio Service) module or a GSM (Global System for Mobile Communications) module.

According to a preferred embodiment of the present invention, the feature recognition module 2 comprises a feature storage module, a human face recognition module and voice recognition module. The feature storage module is for saving the feature database, which comprises the human face feature database and the voice feature database. The human face recognition module recognizes faces of the family members and inquire a human face feature database in the feature storage module, wherein if the faces do not exist, human face feature records are established for the family members. If the face feature record exists, the voice recognition module operates. The voice recognition module to recognize voices of the family members after the faces of the family members are recognized and inquire a voice feature database in the feature storage module, wherein a voice instruction is achieved based on the voice feature and a voice instruction set of the family members is generated and recorded; the voice feature is one-to-one correspond to the voice instruction; wherein the voice recognition module calculates a repeat frequency of a same voice instruction in the voice instruction set and control signals for actions of the unmanned aerial vehicle toward the family member are generated according to the repeat frequency. For example, the most frequently repeated voice instructions are selected as the control signals for actions of the unmanned aerial vehicle toward the family member. The human face recognition is able to be carried out by using the imaging module to scan the face of the family members, record and save the features in the human face feature database; wherein the newly scanned faces compares with the human face features record saved in the database to judge whether the person is a family member or not.

For example, if the most repeated voice instruction from the instruction set of a family member is to instruct the vehicle to keep a distance, the control signal controls the vehicle to keep a distance to the family member; if the most repeated voice instruction from the instruction set of a family member is to instruct the vehicle to come close, the control signal controls the vehicle to be near to the family member. The examples are not a limitation for the present invention. Other voice instructions for controlling the vehicle to act correspondingly are also possible.

According to a preferred embodiment of the present invention, the feature recognition module 2 further comprises a lifeform identification module to identify an abnormal lifeform feature when the route reconnaissance module is under a patrol mode, generate and transmit exception signals to the control module. The lifeform identification module is able to recognize the pets in the house. The pets are identified as a common lifeform and the invading animals as an abnormal lifeform which intrigues an exception signal. The control module receives the exception signal and sound warning signals.

The smart unmanned aerial vehicle for home comprises a warning device 52 to respond to the warning signals from the control module 3 and sound a warning. The warning device 52 is able to adopt a audible warning device or a acousto-optic warning device which is not a limitation for other choice. The warning device is also able to send warning signals to the user terminal or automatically dial the alarm telephone, which warns the abnormal situation in time for people to deal with.

The smart unmanned aerial vehicle for home comprises a charging management module (not shown in the drawings) enables the vehicle to work for a long time automatically. The charging management module checks a charging module power in the vehicle and generate low power return charging signals when the power is low before the low power return charging signals are transmitted to the control model 3; the control module 3 responses to the low power return charging signals and controls the vehicle to return to a charging device for charging along a preset flight route. The charging device is able to be disposed on the preset flight route. The charging electrode of the charging device and the charging electrode of the charging module are able to extend out for a convenient automatic charging when the vehicle flies to the corresponding position. A landing platform is able to be placed for a stable charging.

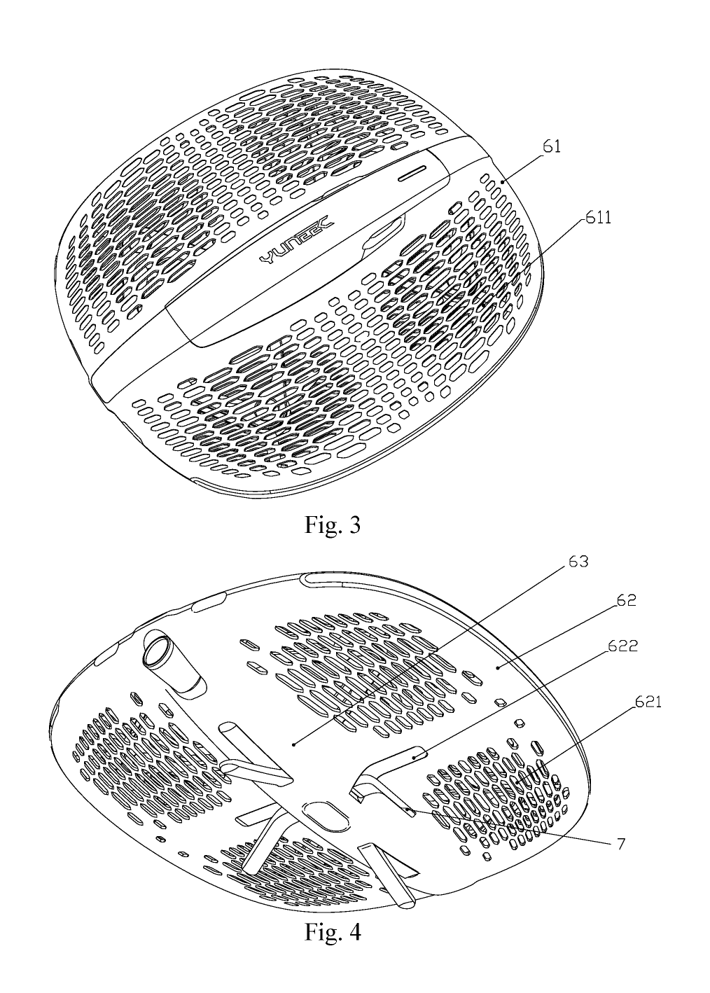

Referring to the FIG. 3 and FIG. 4, according to a preferred embodiment of the present invention, the smart unmanned aerial vehicle for home comprises main body, arms and propellers, wherein the main body connects to the arms on which disposed the propellers. An all-inclusive protective cover surrounds propellers of the vehicle (not shown in the drawings, surrounded in the all-inclusive protective cover, able to be seen through the air holes) inside; multiple air holes are disposed on the all-inclusive protective cover; the propellers are able to rotate freely within the all-inclusive protective cover.

The all-inclusive cover surrounds the whole propellers. While the unmanned aerial vehicle for home frequently runs in the house and the surroundings, the all-inclusive cover protects the propellers from being touched by the human or houseware in all directions, which avoids the possible damages to the vehicle, the houseware or the personnel. The air holes on the all-inclusive cover enable the propellers to provide the airstream power to the unmanned aerial vehicle.

The smart unmanned aerial vehicle for home is small in size which is able to be within 20 cm*20 cm*10 cm. Preferable, the unmanned aerial vehicle is the size of a first of an adult. Modules for reconnaissance and image pickup of the environment are disposed out of the all-inclusive cover.

Preferable, air holes are densely distributed on the all-inclusive cover in the area corresponds to the propellers, which guarantees the smooth flow of air and enables the vehicle to fly with sufficient airstream power generated by the propellers.

According to a preferred embodiment of the present invention, the all-inclusive protective cover comprises a detachable top protective cover 61 and a bottom protective cover 62; the top protective cover 61 and the bottom protective cover 62 surround the main body, arms and propellers within. Air holes 611 are densely distributed on the top protective cover 61 and air holes 612 are densely distributed on the bottom protective cover 62, which enables convection. The top cover 61 and the bottom cover 62 form a shell for the whole unmanned aerial vehicle from the outside and the main body, arms and propellers are all surrounded inside, which are good in appearance and protective for the main body and the arms to a certain extend.

Preferable, a middle part 63 of the all-inclusive protective cover is part of a body shell of the vehicle, which saves cost for producing the body shell and. The body shell is opened when the all-inclusive cover opens, which is convenient for assembly. An accommodating part 622 for a landing gear 7 extension or retraction is disposed on the middle part 63 of the all-inclusive protective cover, which is able to be passed through by or contains the landing gear 7 of the unmanned aerial vehicle. The unmanned aerial vehicle is able to be conveniently stored.

Flexible rubber is adopted for a whole body of the all-inclusive protective cover, the whole body except a middle part 63 of the all-inclusive protective cover and an edge part of the all-inclusive protective cover. The flexible rubble is able to be plastic, rubber and etc. As long as the material is able to be a buffer when the all-inclusive cover hits an object, the material is able to be adopted. The flexible rubber further protects the unmanned aerial vehicle and improves the safety.

According to a preferred embodiment of the present invention, the smart unmanned aerial vehicle for home comprises a holder (not shown in the drawings) which is disposed on the vehicle and extends out from a body shell of the vehicle; the holder is able to fetch, absorb and release objects; the holder responses to a hold instruction from the control module to hold or release an object, wherein the hold instruction is a response to an external hold control signal by the control module 3. The holder enables short distance delivery, or is able to play fetch ball with kids or pets. The holder adopts a clamping device or a suction device. Driving device, such as a motor, is able to be disposed in the unmanned aerial vehicle for the holder.

The preferred embodiments are not a limitation for the claims. One skilled in the art is able to modify and change the embodiments within the spirit and scope of the present invention. The protect range of the present invention is defined by the claims.

What is claimed is:

1. A smart unmanned aerial vehicle, comprising:
a route reconnaissance module being configured to respond to reconnaissance instructions which instruct the unmanned aerial vehicle to patrol a house according to a preset flight route;
a feature recognition module being configured to recognize family members and different reactions of the family members toward the unmanned aerial vehicle for generating and recording an instruction set for the different family members, wherein control signals for actions taking by the unmanned aerial vehicle toward the family to members are generated according to a repeat frequency of instructions in the instruction set; and
a control module being configured to generate the reconnaissance instructions according to external reconnaissance control signals, wherein the control module controls the route reconnaissance module to patrol within a set period of time and the feature recognition module to recognize abnormal features, wherein when exception occurs, warning signals are generated; the control module interrupts a patrol according to an external patrol interruption signal or when the feature recognition module recognizes the family members; the control module responds or waits for a response to the control signals for actions of the feature recognition module.

2. The smart unmanned aerial vehicle, as recited in claim 1, further comprising a vision-based 3D (three-dimensional) scanning module which picks up and transmits house images to the control module during patrol; the control module revises a route preset in the route reconnaissance module based on obstacles along a direction of flight in the house images and adjusts heading of a flight path; the control module is also for comparing the house images picked up in a same spot at different time points, wherein when a distinguishing feature exists, the control module extracts the distinguishing feature and inquires the distinguishing feature in the database; if an inquiry is answered, the control module generates warning signals.

3. The smart unmanned aerial vehicle, as recited in claim 1, further comprising a remote communication module to respond to the warning signals from the control module and call a remote terminal, wherein a communication link is established after a response has been committed, which enables a remote control.

4. The smart unmanned aerial vehicle, as recited in claim 2, further comprising a remote communication module to respond to the warning signals from the control module and call a remote terminal, wherein a communication link is established after a response has been committed, which enables a remote control.

5. The smart unmanned aerial vehicle, as recited in claim 1, wherein the feature recognition module comprises:
a feature storage module for storing a feature database;
a human face recognition module to recognize faces of the family members and inquire a human face feature database in the feature storage module, wherein if the faces do not exist, human face feature records are established for the family members; and
a voice recognition module to recognize voices of the family members after the faces of the family members are recognized and inquire a voice feature database in the feature storage module, wherein a voice instruction is achieved based on a voice feature and a voice instruction set of the family members is generated and recorded; wherein the voice recognition module calculates a repeat frequency of a same voice instruction in the voice instruction set and the control signals for actions toward the family member are generated according to the repeat frequency.

6. The smart unmanned aerial vehicle, as recited in claim 5, wherein the feature recognition module further comprises a lifeform identification module to identify an abnormal lifeform feature when the route reconnaissance module is under a patrol mode, generate and transmit exception signals to the control module.

7. The smart unmanned aerial vehicle, as recited in claim 6, further comprising a warning device to respond to the warning signals and sound a warning.

8. The smart unmanned aerial vehicle, as recited in claim 1, further comprising a charging management module to check a charging module power in the unmanned aerial vehicle and generate low power return charging signals when the charging module power is low before the low power return charging signals are transmitted to the control model; the control module responses to the low power return charging signals and controls the unmanned aerial vehicle to return to a charging device for charging along a preset flight route.

9. The smart unmanned aerial vehicle, as recited in claim 1, wherein an all-inclusive protective cover is disposed at an outside of propellers of the unmanned aerial vehicle; multiple air holes are disposed on the all-inclusive protective cover; the propellers rotates freely within the all-inclusive protective cover.

10. The smart unmanned aerial vehicle, as recited in claim 9, wherein the all-inclusive protective cover comprises a detachable top protective cover and a bottom protective cover; the top protective cover and the bottom protective cover surround a main body, arms and the propellers.

11. The smart unmanned aerial vehicle, as recited in claim 9, wherein a middle part of the all-inclusive protective cover is part of a body shell of the unmanned aerial vehicle; an accommodating part for a landing gear extension or retraction is disposed on the middle part of the all-inclusive protective cover.

12. The smart unmanned aerial vehicle, as recited in claim 10, wherein a middle part of the all-inclusive protective cover is part of a body shell of the unmanned aerial vehicle; an accommodating part for a landing gear extension or retraction is disposed on the middle part of the all-inclusive protective cover.

13. The smart unmanned aerial vehicle, as recited in claim 9, wherein flexible rubber is adopted for a whole body of the all-inclusive protective cover, the whole body except a middle part of the all-inclusive protective cover or an edge part of the all-inclusive protective cover.

14. The smart unmanned aerial vehicle, as recited in claim 1, comprising a holder which is disposed on the unmanned aerial vehicle and extends out from a body shell of the unmanned aerial vehicle; the holder responses to a hold instruction from the control module to hold or release an object, wherein the hold instruction is a response to an external hold control signal by the control module.
